(19) United States
(12) Patent Application Publication
(10) Pub. No.: US 2012/0173403 A1
(43) Pub. Date: Jul. 5, 2012

(54) Systems and Methods For Trading of Privately Held Securities

(76) Inventors: Thomas Sullivan Foley, Woodside, CA (US); David Mack Hiatt Pearl, Los Gatos, CA (US)

(21) Appl. No.: 12/983,252

(22) Filed: Dec. 31, 2010

(51) Int. Cl. G06Q 40/00; G06Q 90/00

(52) U.S. Cl. 705/37; 705/500

(57) ABSTRACT

A system and method are provided for a fully integrated, web-based, electronic trading platform for the primary issuance of private placement securities to pre-qualified and approved accredited investors and qualified institutional buyers. Further a transferable private securities system is provided that supports the secondary sale of securities, including equity shares in venture-backed companies. Embodiments also provide for an auto-execution method for electronic signing of documents required of buyers and sellers of privately held securities and methods for decoupling preference rights from common stock for privately held securities.

### FIELD

The present invention relates generally to providing a system for private companies to raise capital as part of a primary offering and for the secondary trading of securities, such as equities or other forms of investments in privately held companies, amongst qualified investors, over a network and, more particularly, but not exclusively to enabling investors to enter place buy orders in primary offerings and buy and sell orders in secondary trading.

### BACKGROUND

The sale of private securities has historically been done between two individuals or through a broker whereby the transaction takes place after the placement of telephone calls, negotiation and a paper transaction. With the advent of the Internet and online brokerages, investors have more and more alternatives when choosing investments today and often act independently without consulting a professional in the investment industry. Information regarding investments in public companies is readily available. However, information concerning investments in private companies is still scarce and difficult to obtain. Furthermore, there is a high demand to invest in private companies but no true marketplace for shares of privately held companies. There is also a need to make such privately held shares liquid in order to attract investors who may not want to hold the shares long term, and give current holders of such securities ways of achieving liquidity.

As a result there is a need for a trading platform for private securities. Embodiments of the present invention provide novel trading systems that include among other things, an electronic order entry system that affords investors the ability to enter buy orders as part of a company raising capital in a primary issuance and for investors to place buy and sell orders in secondary trading of privately held companies pursuant to Regulation D of the Securities and Exchange Act of 1933 and SEC Rule 144A respectively.

### BRIEF SUMMARY

In accordance with an embodiment of the present invention a system for transferring privately held securities is provided. The system includes a host processing module, accessible to a buyer over a network, having access to a database module storing information about at least one issuing company's private offerings; an authorization module accessible to the host processing module adapted to receive a permission request from the buyer and to obtain permission from the at least one issuing company; a bid/ask module accessible to the host processing module, adapted to receive bids from the buyer and asks from at least one issuing company; a reporting module, adapted to compile matching bids and asks; and a clearing module, adapted to clear and settle the transfer of matching bids and asks.

In accordance with another embodiment of the present invention, a system for transferring privately held securities is provided. The system includes a host processing module, accessible to a buyer over a network, a database module, accessible to the host processing module, an authorization module accessible to the host processing module adapted to receive a permission request from the buyer; an authorization module, adapted to receive the permission request to obtain confidential information pertaining to an issuing company from the database module and to obtain permission from the issuing company, a bid/ask module accessible to the host processing module, adapted to match bids and asks for privately held securities, a reporting module, adapted to compile matching bids and asks, a clearing module, adapted to clear and settle the transfer of matching bids and asks; and an electronic execution module adapted to populate and execute share transfer documents on behalf of the issuing company and the buyer.

Other objects, advantages, and applications of the embodiments of the present invention will be made clear by the following detailed description of a preferred embodiment of the present invention. The description makes reference to drawings in which:

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIG. 1 shows a networked environment illustrating one embodiment of one environment for practicing embodiments of the present invention;

FIG. 2 shows one embodiment of a device that may be included in a system implementing embodiments of the invention;

FIG. 3 shows one embodiment of a network device that may be included in a system implementing embodiments of the invention;

FIG. 4 illustrates a logical flow diagram generally showing one embodiment of a process for automatic execution of documents with electronic signatures; and

FIG. 5 illustrates a logical flow diagram generally showing an showing an embodiment of a process for granting permission for trading of private securities;

FIG. 6 illustrates a logical flow diagram showing an embodiment of a process for trading private securities; and

FIG. 7 illustrates an embodiment of a transferable private securities system.

### DETAILED DESCRIPTION OF PREFERRED EMBODIMENTS

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements.

Briefly, embodiments of the present invention are directed to systems, and methods that facilitate electronic trading of restricted securities. The systems and methods include but are not limited to the enabling of automatic e-execution of documents, a permission based system, order entry system, creation of a new more liquid security, and a trading system. While embodiments of the present invention are described in conjunction with applications in the privately held securities field, it is equally applicable to any illiquid item such as but not limited to real estate, limited partnership interests, automobiles, and personal property.

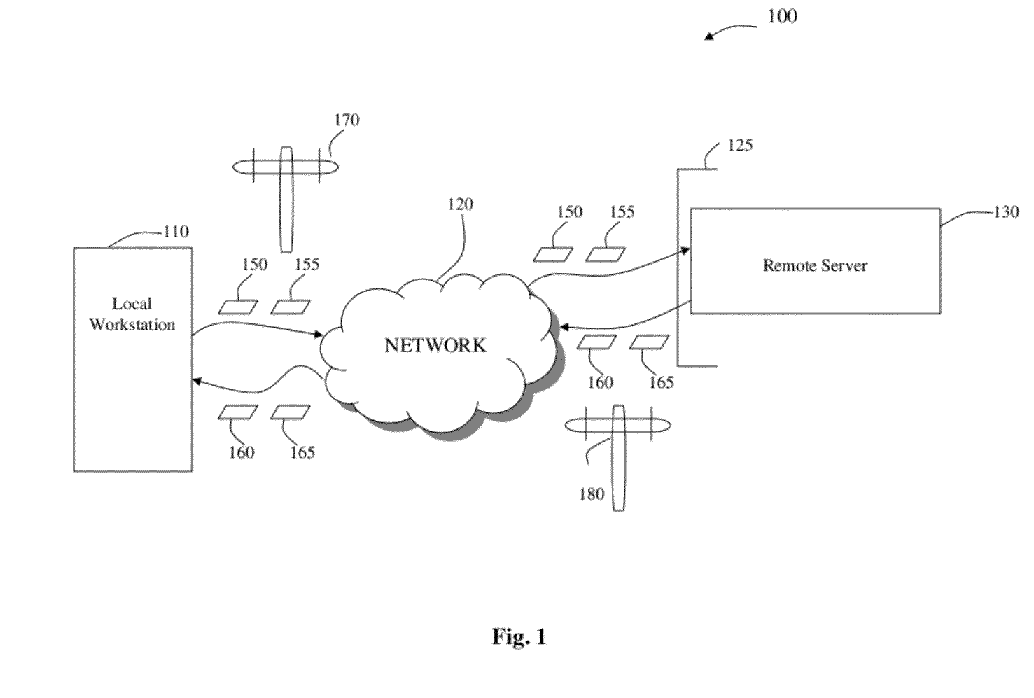

Turning now to the drawings, FIG. 1 is a block diagram of an exemplary system 100 for trading privately held securities via a network 120 from a local workstation 110. The system 100 enables access and delivery of information related to a user, a user's actions, order type, share quantities, share prices, activation price and fulfillment options between the local workstation 110 and a server 130. FIG. 1 shows components of one embodiment of an environment in which the invention may be practiced. Not all the components may be required to practice the invention, and variations in the arrangement and type of the components may be made without departing from the spirit or scope of the invention. The network may be any network such as a Local Area Network (LAN), Wide Area Network (WAN), an Extranet or the Internet. However, in a preferred embodiment, the network 120 is the Internet. Although only one remote server 130 and local workstation 110 is depicted, one skilled in the art will recognize that any number of remote servers and local workstations may be utilized.

The network 120 is coupled to the local workstation 110 through a communication link 170, such as a wireless connection, phone line, modem, ISDN, cable line, digital subscriber line, infra-red link or the like. The network 120 is also coupled to the remote server 130 through a communication link 180, such as a wireless connection, phone line, cable line, digital subscriber line, infra-red link or the like. The local workstation 110 is a client that can be coupled to the network 120 via the communication link 170. The local workstation 110 may be a personal computer, laptop computer, handheld computer, mainframe computer, PDA, smartphone, mobile device, netbook or any other device capable of computing, data processing or the like. Alternatively, the local workstation 110 may be a thin client with all of the processing done remotely. Although not shown, remote data storage could also be connected to the local workstation 110. The communication link 170 between the workstation 110 and the network 120 allows workstation data 150 and queries 155 to be transmitted from the workstation 110 to the network 120. The communication link 180 between the network 120 and the server 130 transmits workstation data 150 and queries 155 from the network 120 to the remote server 130. The remote server may be protected by a firewall 125. Similarly, the communication link 180 between the server 130 and the network 120 allows server data 160 and inquiry data 165 to be transmitted from the server 130 to the network 120. The communication link 170 between the network 120 and the workstation 110 transmits the server data 160 and the inquiry data 165 from the network 120 to the workstation 110. While illustrated as a single server 130, there could be multiple servers. Similarly, while a single workstation is depicted, one of skill in the art will understand that multiple workstations are contemplated within the scope of embodiments of the present invention.

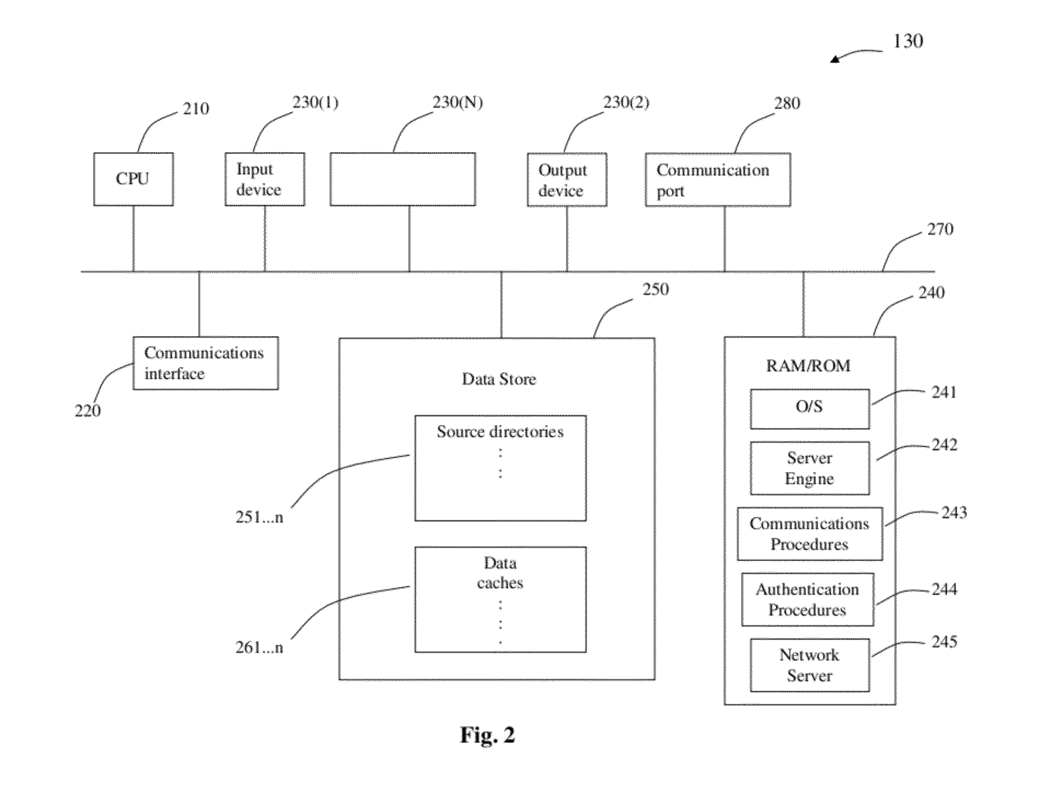

FIG. 2 is a block diagram of the remote server 130 shown in FIG. 1. The remote server 130 contains a plurality of components which may include central processing units (CPU) 210, communications interfaces 220, a communication ports 280, ports 230(1)-(N), where the ports may include input and output devices, such as a monitor and keyboard and “N” is any number; memory 240 of various kinds; data storage components 250 and circuits 270 that connects the aforementioned components. The server also includes several modules including but not limited to a host processing module, a database module, an electronic execution module, permission module, a waiver module, an authorization module, a bid/ask module, a reporting module, a finalization module and a clearing module. The modules may include software adapted to execute instructions and/or memory to store information. The communications interface 220 and the communications port 280 preferably include one or more Network Interface Cards (NICs) configured to communicate with the network 120 and the local workstation 110. The memory 240 preferably comprises Random Access Memory (RAM) and/or Read Only Memory (ROM). The memory 240 preferably includes an operating system 241 which has instructions for communicating, processing, accessing, storing, or searching data. Non-limiting examples of suitable operating systems include MICROSOFT WINDOWS™, DOS™, UNIX™, LINUX™ and MAC OS™ which have instructions for communicating, processing, accessing, storing, and searching data. In addition, memory 240 preferably includes a server engine 242, communication procedures 243, authentication procedures 244, and a network server 245. The data store 250 includes source directories 251 . . . N containing software modules including application modules, data modules, management/replication modules, logic processing modules, and database modules, The software provides for at least the following: signing up new users, enabling users to log in, viewing of securities, offering and buying securities, entering secure account information and password data, establishing an account, collecting funds, and sending and receiving web-based communication (email, instant message, chat, SMS, MMS, etc.), and cache 261 . . . N for handling data such as user and/or prospective user information.

The communications procedures 243 are used for communicating with both the local workstation 110 and the network 120. The authentication procedures 244 are used for authenticating users. Successful completion of the authentication procedures gives users access to the data on the server.

The remote server can also be implemented as one or more “blades” where the term “blade” refers to one of multiple electronic circuit boards or cards that are installed in a hardware chassis with a backplane. An exemplary blade may include one or more processors, volatile and non-volatile memory, interfaces suitable for communicating information to and from the blade, and other components for enabling the operation of one or more applications. A blade may also include a specialized interface for the backplane and other interfaces, such as a USB port, FIREWIRE port, serial port, RF interface, IR interface, Ethernet interface, IDE controller, and the like. An application running on a blade may employ any of these interfaces to communicate information to other applications running on other blades and/or devices coupled to the blade server. The remote server can also be implemented as a combination of blades and additional components in the chassis.

In another embodiment, the remote server is implemented as a combination of multiple machines, where parts of the communications procedures are on different machines than the data, and the data itself is stored on different machines. For example, a standard web server configuration where network security is improved by dividing the web server from the data storage. In addition, these combinations of machines may be distributed over multiple data centers that are distributed geographically.

Furthermore, embodiments of the present invention may be practiced on a cloud computing system such that the server is on the cloud.

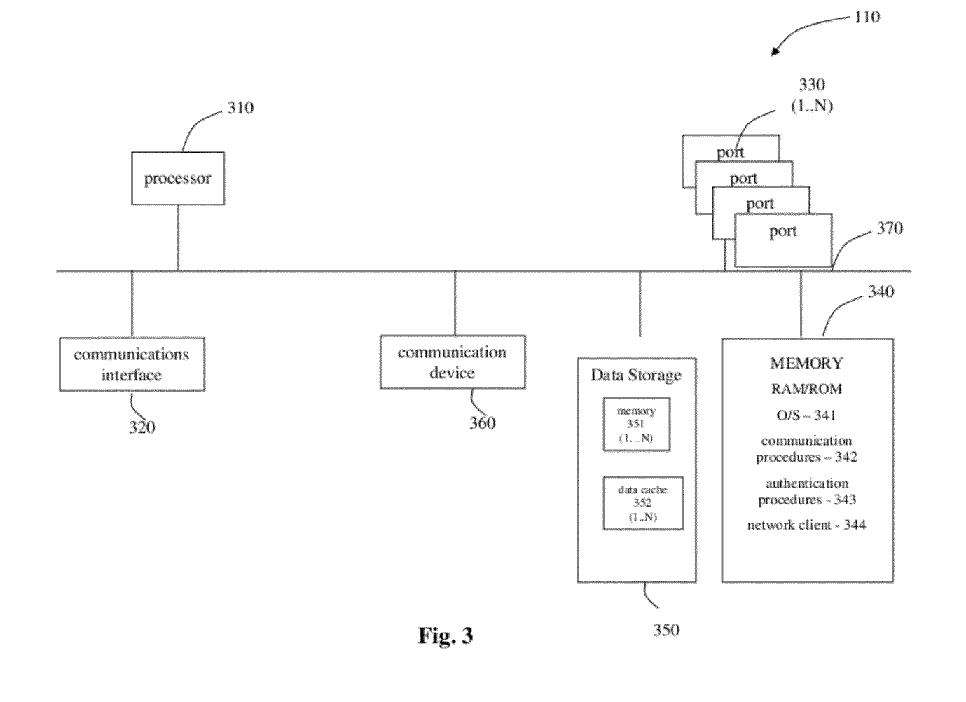

FIG. 3 is a block diagram of an exemplary local workstation 110 such as that shown in FIG. 1. The local workstation 110 comprises a plurality of components, such as a central processing unit (CPU) 310; communications interface 320; ports 330(1)-(N), where the ports include input and output devices, such as a monitor and keyboard and “N” is any number of devices; a memory 340; a data storage component 350, a communications device (i.e., modem) 360, and at least one bus 370 that connects the aforementioned components. The memory 340 preferably comprises Random Access Memory (RAM) and/or Read Only Memory (ROM). The memory also preferably includes an operating system 341, such as MICROSOFT WINDOWS™, DOS™ UNIX™, LINUX™, or MAC OS™, which has instructions for communicating, processing, accessing, storing, and searching data. The memory 340 further includes communications procedures 342, and authentication procedures 343, and a network client (web browser) 344.

The RAM preferably also has instructions for communicating, processing, accessing, and searching. Communications procedures are used for communicating with the network 120. Authentication procedures are used to authenticate the local workstation's 110 access to the remote server 130. Installation procedures are used to download and install necessary software and software modules onto the local workstation 110. In another embodiment, the user downloads all applications or installs such from media and the method is executed locally. In such an embodiment, updates may be provided and such updates may be obtained through the network or by supplying additional media. The configuration data contains the local workstation configuration information, such as the hardware and software that makes up the local workstation 110.

A network client 344 receives content or server data 160 from the remote server 130. The network client 344 is preferably a web based browser or similar type program, such as MICROSOFT'S INTERNET EXPLORER™, NETSCAPE'S NAVIGATOR™. MOZILLA FIREFOX™, GOOGLE CHROME™ or SAFARI™. The data storage 350 includes memory 351 (1 . . . N) for storing data and reports, and data caches 352 (1 . . . N).

Generally, embodiments of the present invention, provide a novel private securities trading system, for trading privately held securities, including enabling access and delivery of information related to a user and a user's actions, order type, share quantities and price, activation price and fulfillment options. Although the various embodiments are described with respect to privately held preferred stocks, it is contemplated within the scope of the embodiments of the invention that the systems and methods described are equally applicable to other alternative private asset investments.

Auto Sign Documents with E-Signature:

One aspect of the purchase of private company securities is the signing of various documents including, but not limited to: (i) stock purchase agreement, (ii) voting agreement, (iii) investor rights agreement, and (iv) stock restriction agreement. In order for these documents to be valid, such documents must be executed by the buyer, seller, and issuer as applicable. On the public markets, these documents are not necessary because the rights and obligations created by the documents are not customarily applicable to publicly traded equities, and because the transfer of shares in the public markets is governed by a well-developed regulatory structure that is much less developed in the private market.

Because the aforementioned documents need to be signed as part of any private security transaction, the current process is that a buyer, seller, and issuer reach an agreement as to the terms of the purchase, and then the various documents are drafted and/or amended to reflect the terms of the purchase. However, this formality sometimes results in deals falling apart, as a buyer or seller might forget or refuse to execute the documents even after a deal has been reached. This can result in failing, or even if the deal doesn't fail, it results in delays that impede the transferring of the underlying securities.

Because the required formalities sometimes present challenges, embodiments of the present invention provide for a novel auto-execution combined with an E-signature for all stock purchases on both primary and secondary private securities markets.

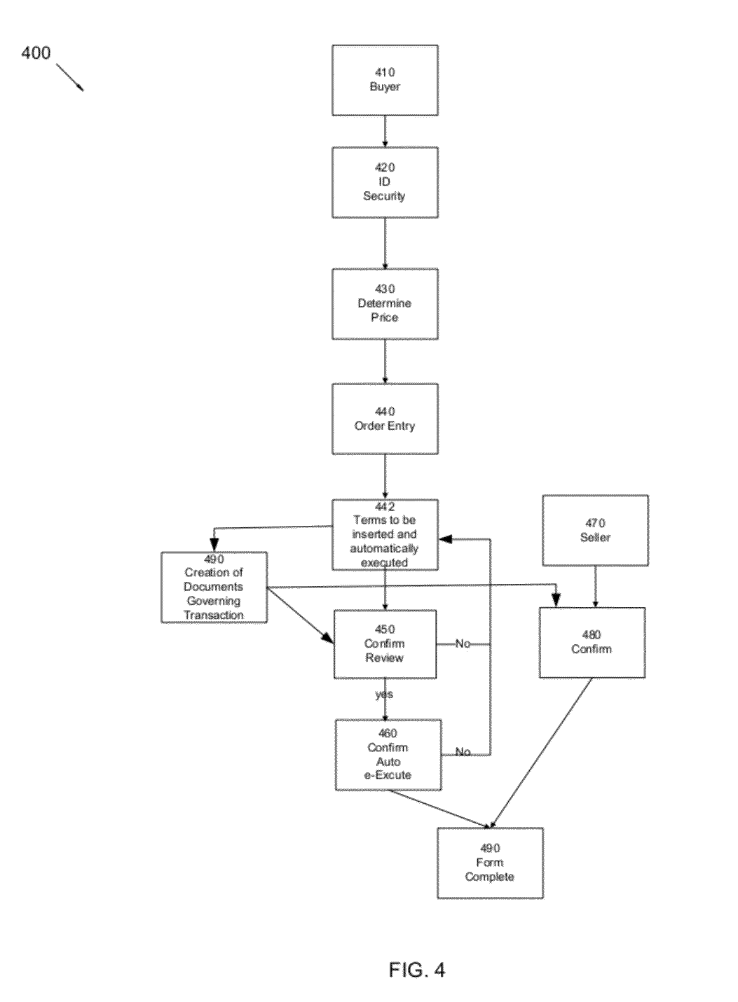

FIG. 4 illustrates a method 400 for automatic signing with e-signatures.

The method 400 begins with a buyer 410 identifying a security that the buyer wishes to purchase 420 as part of an Issuer's primary offering or on the secondary trading floor. Once the buyer determines a price that he will pay for the security 430, the buyer completes an electronic order entry form 440. The order entry form 440 has the typical inputs, i.e., security trading symbol, type, quantity, price and any other information that may be desirable. As part of the order entry form, the buyer 410 must confirm that he has reviewed the required documents and agrees that if a transaction is executed, that the terms of the transaction will be inserted into the corresponding documents, and also agrees that the documents will be automatically executed on his behalf 442. The confirmation is completed, and consequently the order entry form by checking two boxes stating that the user has reviewed the documents and that the user agrees to auto-e-sign all documents associated with the transaction. The confirmation could also be completed via audio methods, or through other acknowledgement means and such are contemplated within the scope of the embodiments of the present invention. The spirit of the embodiments is merely that the buyer confirms acceptance of electronic execution and that such e-signature is legally binding. The first box contains the language indicating the buyer has reviewed all documents associated with the purchase of the securities, for example, “I certify that I have read all of the documents associated with the purchase of these securities.” When the user clicks this first box 450, it automatically causes each of the documents to be individually viewed across the screen, with the user having to click “Next” in order to move to the next document. Following the reading of each of the documents, the user will be able to check the first box 450 on the order entry screen, which was previously grayed out. Unless the user clicks through all of the documents, the first box on the order entry will remain grayed out and the user will not be able to enter the order. In an alternative embodiment, following the reading of each of the documents, the box on the order entry screen will automatically be checked. In an alternative embodiment the buyer must check a box after each document that is displayed or alternatively a box may be automatically checked after each document is displayed. In an alternative embodiment, the system does not verify that the buyer has read the documents, and also does not require that the buyer check a box stating that he has read the documents. In yet another embodiment, the buyer is able to download and save a particular viewed document. In another embodiment, the buyer is able to download and save all viewed documents with a single request. In another embodiment, the buyer may agree to the auto-e-execution of documents once per company or once per security, rather than once per order. If the buyer 410 fails to confirm review of the documents, the method 400 will not continue and the buyer is redirected to the original agreements to acknowledge electronic processing 442.

In another embodiment, a buyer does not agree to the auto-execution of documents, and following a transaction, the documents are created and emailed or hard copy transmitted to the parties for signature.

The second box 460 contains language indicating the buyer agrees to the e-execution of documents, for example, “I hereby agree that in the event that a transaction is executed, Xpert Securities may insert the terms of the transaction into these documents, and may execute these documents on my behalf.” The buyer 410 will only be able to check the second box 460 if the first box 450 certifying that the buyer 410 has read all of the documents is checked. However, the user cannot make the order unless the second box 460 is also checked. As part of a private offering, the buyer is required to agree to the auto-e-execution a stock purchase agreement, voting agreement, investor rights agreement, right of first refusal/co-sale agreement, or any other document associated with the offering. As part of a secondary transaction, the buyer is required to agree to the auto-e-execution of a stock purchase agreement, adoption agreement, notice of financing agreements, and a notice to purchaser. These documents are created 490 based on the agreed terms prior to auto e-execution.

In a similar manner a seller is required to click both the review of documents and the auto-e-execute boxes on the order entry form. For example, in a secondary trade the seller however, will have to review the stock purchase agreement and assignment separate from certificate, during the auto-execute.

Similarly, when a company 470 or issuer lists its shares on either the private offering or secondary trading floor, the issuer is required to agree to the auto-e-execution any documents associated with the sale 480. As part of a private offering, the Issuer will have to execute a stock purchase agreement, voting agreement, investor rights agreement, and right of first refusal/co-sale agreement, or any other necessary documents. As part of a secondary transaction, the Issuer will have to execute the stock purchase agreement and an adoption agreement.

In conjunction with the close of a private offering, the terms of the purchase will automatically be entered into a stock purchase agreement 490. The software will automatically insert the buyer's name, price, number of shares, etc. into all of the documents associated with the transaction. The transferable private securities system, based on the authorizations detailed above, will auto-e-sign the document for both the buyer and the issuer. On the secondary trading platform, the terms of the purchase will be automatically inserted into a stock purchase agreement and auto-e-signed for the buyer, seller and Issuer. Likewise, all of the corporate documents that govern the shares the buyer purchased will be auto-e-executed on behalf of the buyer, seller and issuer.

In one embodiment, the seller or buyer confirms that in accordance with the use of the transferable private securities system, he will agree to the use of e-signatures generally before accessing the system or requesting permission to purchase, as described below. In the case of a buyer, in such an embodiment, the buyer first is confirmed to be a qualified buyer eligible to purchase such securities. Once it is determined that the buyer is eligible then the buyer confirms he will agree to the use of e-signatures generally. However, the buyer will still be required to electronically execute documents in conjunction with each transaction. Similarly, the seller confirms he will agree to the use of e-signatures generally. However, like the buyer, the seller will still be required to electronically execute documents in conjunction with each transaction.

In an alternative embodiment, the seller or buyer, after confirming that he will agree to the use of e-sign, instead of automating the e-sign, uses a signing room where each party logs in and then e-signs the documents after the trade has already been executed on the system.

In an alternative embodiment, instead of using automated signatures, the documents will be created by the software based upon the terms of the transaction, and physical copies of the documents will be emailed or mailed to the buyer, seller, and issuer for execution.

Permission Based System and Order Entry System:

A permission based system for all applications across a private securities trading platform is provided. The system enables an issuing company to determine which users have access to their corporate information contained on the platform as well as who is able to purchase their securities on the transferable private securities system. As a result of the permission based system, issuing companies are able to waive their rights of first refusal and co-sale that typically applies to private securities solely when the securities are listed on the platform (the right of first refusal and co-sale will continue to apply off of the platform). The right of first refusal and co-sale are an important aspect of the transferable private securities system for a variety of reasons including, but not limited to, allowing privately held companies to maintain control over who purchases a company's shares and who are the investors in the company. Conventionally, when a shareholder in a privately held company sells shares to a buyer, the right of first refusal is triggered, which then allows the company or existing shareholders to purchase the shares at the same price as the offered price. This right is important as it prevents a competitor or disinterested buyer from obtaining shares in the privately held company. The permission based system provided herein provides a novel automated way for the issuing company to exercise or waive the right of first refusal by exercising control on the front end, rather than after a proposed sale occurs. In order for a seller to sell private securities on the system, i.e., as the secondary sales, the issuing company must enter into a listing agreement that approves the listing of shares, with one requirement being the waiver of the rights of first refusal and co-sale when traded on the platform. Only company authorized shares are able to be offered on the transferable private securities system.

All participants in the privately held securities transaction are prohibited from disclosing information, including quotations, transactions and other information displayed on the platform, to any third party. The disclosure prohibition is a contractual obligation that may be waived in another embodiment. Furthermore, the private securities trading system does not disseminate information to the public, or allow general public access without registration as such may be considered a prohibited general solicitation.

If the user accessing the private transferable securities system is an Issuer wishing to offer shares for sale as part of a primary offering, prior to the issuer initiating the offering it must complete an agreement that contains representations and warranties that the company is not required to register the securities with the SEC, and that an exemption from registration exists for the sale of the issuer's securities. In addition, the issuer submits a copy of its shareholder registry and current financials so that the private transferable securities system can confirm that the issuer is qualified and meets the listing standards to participate in such a system.

After an issuer is approved to offer securities on the private transferable securities system the issuer must complete at least an X-1, which is simplified format of a SEC S-1 registration statement and is equivalent to a private placement memorandum in a standardized form. The company may record and upload a virtual road show video and a question and answer informational video that is available for potential investors to view any time following the actual road show, provided the investor has requested and received permission from the company to view the road show. In another embodiment, the road show and/or the question and answer informational video is not required. Similarly, in another embodiment the X-1 is not required. Generally, it is desirable to match disclosures that are customary in the market, however, it is contemplated within the scope of the embodiments that any or all company or seller disclosures may be waived, or requirements may be modified in accordance with acceptable practices.

The issuer also is required to upload audited financials prepared by a reputable accounting firm, including but not limited to balance sheet, income statement, and cash flow statement, as well as a capitalization table prior to an initial private offering. These same financial statements are required prior to a secondary trading. Financials may be required for the most recently completed fiscal year or for multiple fiscal years. In another embodiment, financials are not required.

The transferable private securities system is also contemplated to enable existing shareholders to offer shares for sale. However, prior to existing shareholders posting shares on the transferable private securities system for secondary trading, the issuer will first have to have been authorized for entry into the transferable private securities system as described above. After an issuer is approved to list its shares, the issuer is also required to provide supporting documents for the shares that will be listed on the transferable private securities system, including but not limited to any Investor Rights Agreement, Right of First Refusal and Co-Sale Agreement, Voting Agreement, and any other documents that will govern the shares to be sold by existing shareholders. All of these documents must be uploaded before allowing existing shareholders to list shares for sale. After the issuer completes the required formalities, existing shareholders can post their shares for sale.

Prior to posting shares, a shareholder (or “seller”) must execute a Sell Side Participant Agreement wherein the seller makes certain representations and warranties about his ownership of the securities to be sold and his right to transfer the same, as well as certain representations and warranties in support of an exemption from the Securities Act. It will then be manually verified by contacting the company or company's transfer agent that the seller is a bona fide shareholder and that the seller owns at a minimum at least the number of shares being offered.

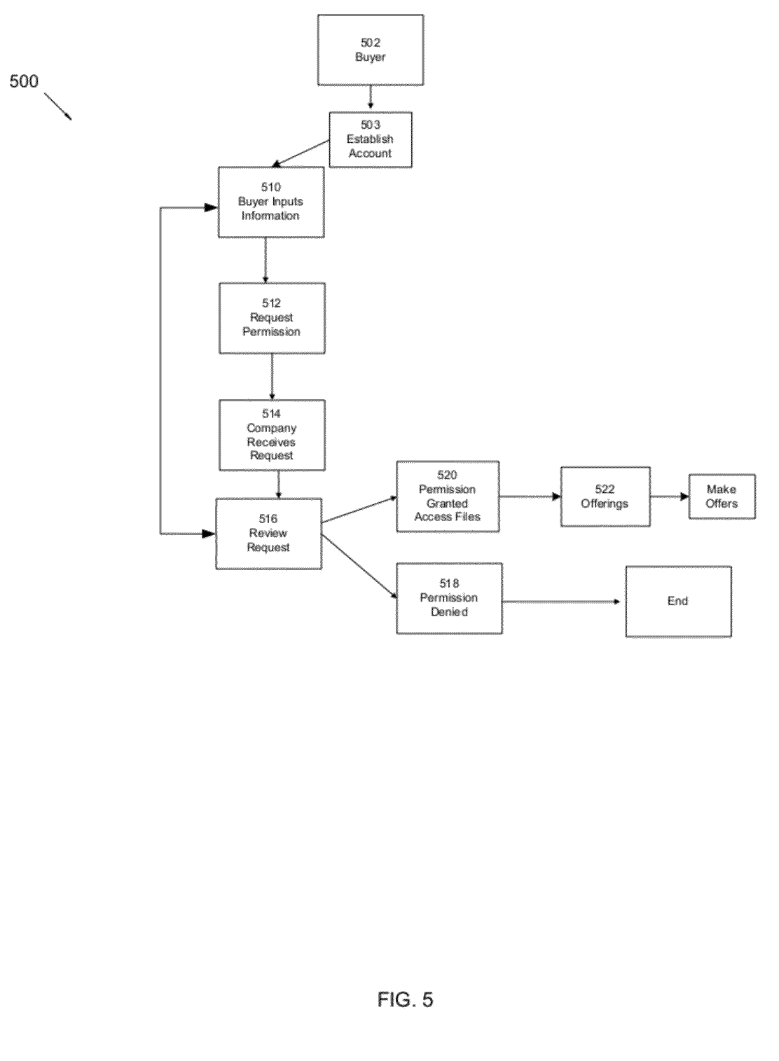

Turning to FIG. 5, FIG. 5 illustrates a process 500 for granting permission to a buyer 502. Once the private securities are made available, the system also enables a company to have the control to authorize access to buyers. A buyer 502 accesses either the secondary trading floor order book or the primary offering portal via an upcoming or current offering page. If a buyer 502 sees a company in which the buyer is interested, the buyer 502 first requests the company's permission 512 by clicking on a “Request Permission” button on the company's portion of the website. This action immediately sends a request to the company 514. The company has a portion of its account set up for reviewing incoming permission requests 516. The company clicks on the buyer 512 that has requested permission 512, the company is then able to view a summary of the buyer 510, as well as the buyer's accredited investor questionnaire or qualified institutional buyer certificate depending upon the type of buyer. The company then can either approve or deny the potential buyer 502, at the company's sole discretion. The company's approval or denial may be necessary for either or both primary and secondary offerings.

Prior to being approved, the buyer is unable to see the securities listed for sale or to make an offer, as part of either a private offering or on the secondary trading floor. Therefore, until approved, when the buyer clicks on the trade book for the company, the buyer will not see any bids or asks. However, once the buyer obtains permission 520, the buyer is able to see the entire bid/ask spread for the company 522 on the secondary trading floor. The trading account is preferably linked to liquid funds that are readily available for use. All significant actions involving trading accounts (including order cancellation) require a two-factor authentication process for security reasons. For example, a user name and password, and a one time password (OTP) token number from a pseudo-random number sequence. This security is designed to help guard against web attacks and divulgence of credentials. Further, once permission is granted by the system and the issuer authorizes the buyer 502, the buyer 502 can make a bid on either a private offering or the secondary trading floor for the company/issuer that has granted it permission. When a buyer 502 makes a bid on either a private offering or the secondary trading floor, an order confirmation screen is created, where the buyer 502 will have to input a unique OTP token number that is unique to the buyer. In a preferred embodiment, the buyer obtains the token identifier or other security measure during the initial sign-up. The OTP token provides a further level of protection that the buyer is who the buyer says it is.

Similarly, on the other side, when the buyer requests permission of the company 514, and the company grants the buyer permission 520 to view their information and purchase shares on either private offering or the secondary trading floor, if the buyer tried to place an order, the buyer is first directed to view a copy of the company's X-1. The company's other documents, including audited financials, will be available for view by the Buyer on the platform. Although referred to as electronic, this is not intended to be a limitation on the embodiments and it is contemplated within the scope of the embodiments that the buyer could request a hardcopy be sent or that the buyer could receive the documents in email form.

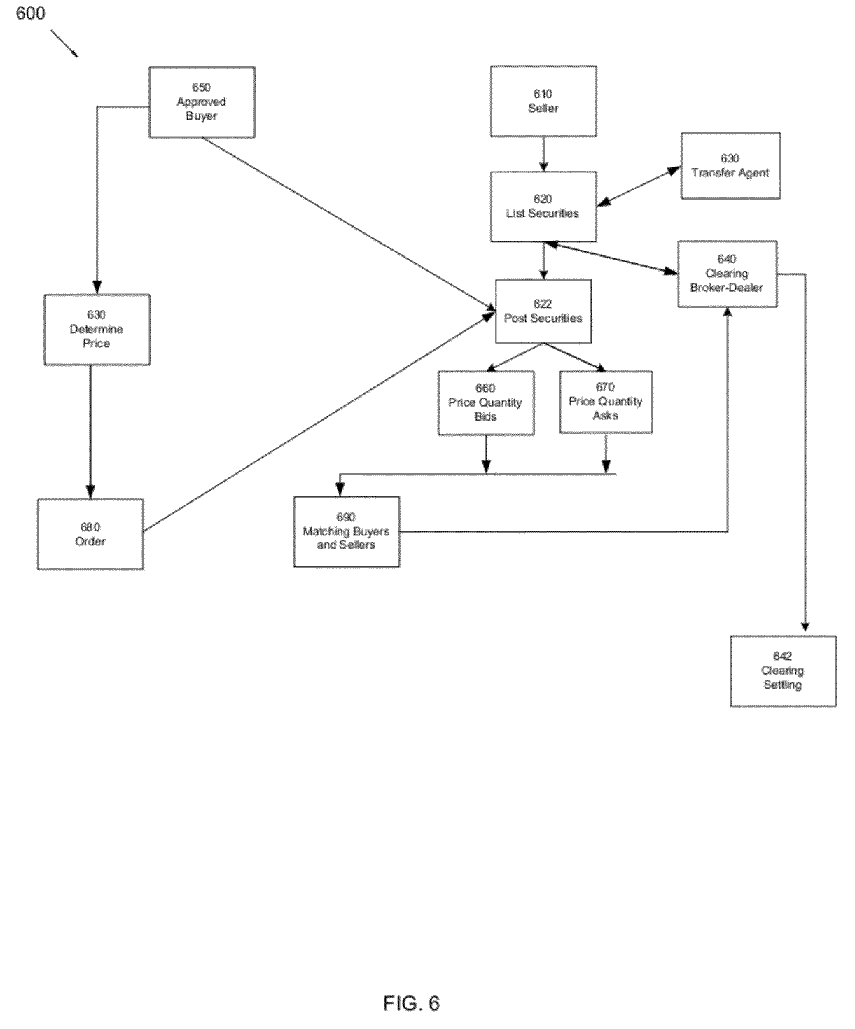

FIG. 6 illustrates a method 600 for trading private securities transactions.

In one embodiment, the transferable private securities system 600 acts as an introducing broker-dealer. As a result, the transferable private securities system does not hold client funds or stock certificates for its users. Therefore, a third party, such as Legent Clearing, LLC is contracted with to serve as a clearing broker dealer 640.

In an embodiment of the present invention, a seller 610 lists securities that it wants to sell on the trading floor 620. The transferable private securities system 600 confirms with a transfer agent 630 that the seller 610 owns the shares that are being offered, and the shares are then sent by the Seller to a clearing broker dealer 640 for safekeeping. After the clearing broker-dealer 640 confirms receipt of the stock certificate, the seller 610 is able to post the securities for sale on trading floor 622. In another embodiment of the present invention, the securities are held in book entry form with the Issuer's transfer agent, and the certificates are never sent to the clearing broker dealer.

A prospective buyer 650, after being approved by the company as described above, is then be able to view the details of the order book on the trading floor 622 including the shares that a seller lists.

Once approved, the buyer 650 as well as the seller 610 have access to the order book allowing each to view all of the outstanding bids and asks in relation to that company's securities on the transferable private securities system 600. Both buyer 650 and seller 610 appear anonymous, but are able to see the price and quantity of all the bids 660 and asks 670 for the company for which each is approved.

When the buyer 650 finds a stock that it wants to purchase, the buyer 650 may determine a price 630 and enter an order 680 which is recorded and shown on the order book 622.

The transferable private securities system matches bidders and sellers 690 as orders come in. Included in the programming is the ability to execute market orders, limit orders, stop limit orders, stop orders, and other transactions conventionally provided for in exchange systems.

When a bid 660 and ask 670 cross on the transferable private securities system, the bid 660 and ask 670 are immediately removed from the order book and submitted to the clearing broker dealer 640 for the clearing and settlement process 642.

The transferable private securities server communicates through a secure communication link or line, a VPN tunnel or any other appropriate form of dedicated secure communication with a clearing broker-dealer server 640 the trade information. Such a line for example, is a dedicated BL Server line such as that maintained by Legent Corporation. The clearing broker-dealer 640 in turn, in cooperation with the issuer of the private security has the original certificate in the name of the seller cancelled and re-issued in the name of the buyer 650. Upon confirmation that the securities have been re-issued in the name of the buyer, the clearing broker-dealer 640 will transfer the funds from the buyer's account into the seller's account.

The clearing broker-dealer 640 updates the records to reflect that the transaction has been consummated, and communicates this fact to the system, which then updates to show that the transaction has cleared, and that the shares are now available to the buyer and the funds are now available to the seller.

In another embodiment, the company that owns the transferable private securities system is enabled to register with the Financial Industries Regulatory Authority (FINRA) as a self-clearing broker dealer. As a self-clearing broker dealer, the transferable private securities system holds securities, and holds client's cash. In such an embodiment the process proceeds are described above but without the need for the clearing broker-dealer 640. Further, in such an embodiment, the transferable private security system would become the company's transfer agent, and record share ownership in book-entry form rather than holding physical certificates which would effectively create digital shares. The transferable private security system could then transfer shares on behalf of the company, as well as transfer funds. In an alternative embodiment, self-clearing broker dealer would not become the company's transfer agent, and would replace the need for a third-party clearing firm such as Legent Clearing, LLC.

Embodiments of the present invention further provide a novel process for de-coupling the rights associated with the various levels of preferred privately held stocks so that only two classes of equity securities remain. Traditionally, each series of preferred stock has its own set of rights and preferences that attach to the shares. As a result, it is difficult for investors to value the various types of preferred stock. Traditionally, equity in private companies consisted of two distinct types of securities: Common Stock and Preferred Stock. The Preferred Stock may further broken down into different Series, with each having its own rights, liquidation preferences and valuation. These rights and preferences are typically included in the original stock purchase agreement, investor's rights agreement and voting agreement between the investors and the company. As a result, because the rights and preferences attached to each Series vary, valuing each Series is extremely difficult, often inaccurate and burdensome. Until a company goes public or is acquired and the valuation of each share is established, this uncertainty hinders the free transferability of the shares. To solve this liquidity problem and allow for the free transferability of Preferred Stock a novel “de-coupling” of the preferred rights from Common Stock has been developed.

The process herein decouples the rights and preferences from preferred stock and creates one type of Common Stock plus one type of preferred equity (without participation rights or voting rights).

Conventionally, in the event of an IPO or M&A, shares of Preferred Stock, based upon the rights and original conditions of issuance, are converted to Common Stock, the conversion ratio is dependent upon the sale price of the company and the number of outstanding shares. The process herein provides a means for “de-coupling” the preferred shares prior to a liquidation event in order to create a common tradable stock, without completely eliminating all of the preferences and benefits associated with owning the preferred Series.

First, the shares of Preferred Stock are converted into an identical number of shares of Common Stock. Then a value of the preferred piece is determined. This additional amount of preference is called a “Slug”. As such each share of Preferred Stock yields one share of Common Stock, and a Slug that is paid off prior to any distributions or payment to the Common Stock. The Slug however has zero voting rights and zero participation rights at the time of a liquidity event. In addition, the Slug may optionally contain an annual dividend amount. Once the “decoupling” is complete, all voting is associated with the common stock, and each shareholder would have one vote. In an alternate embodiment voting preferences are retained and the stock is appropriately valued.

The decoupling process enables a company or shareholder to list its shares on the private transferable securities systems. As part of the “de-coupling” process, the shareholder receives the exact number of common shares that were previously held as preferred shares, and the shareholder retains the slug until a future liquidity event or if the Company desires to pay off the Slug. At a liquidity event, all of the outstanding Slug pieces will be first paid, and then the common stock would be paid pro-rata.

The novel “de-coupling” process provides for a single class of Common Stock that can be actively traded in addition to the trading of a Slug. The initial pricing of the Common Stock would be based on the most recent round of financing, or optionally may be set by the Company, but once publicly traded, its price would be set by the open market.

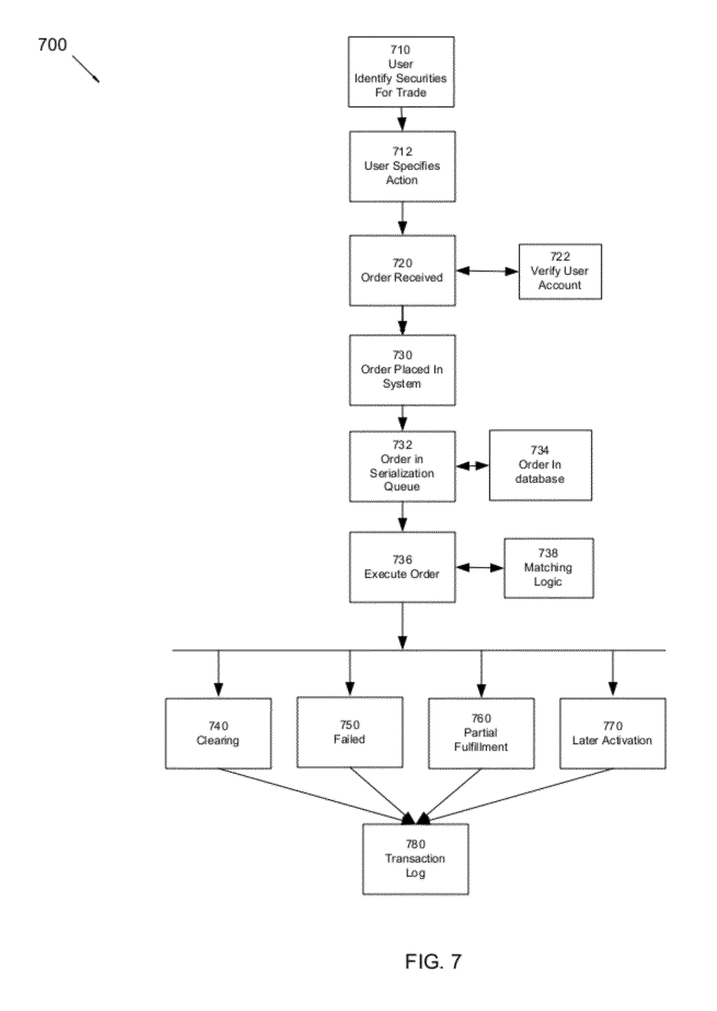

FIG. 7 illustrates an embodiment of a transferable securities system 700.

In the system 700, a user specifies the symbol for the company whose securities he wishes to trade 710, the user specifies an action 712, which may include the following parameters: Bid or Ask, the order type, e.g., Limit, Market, Stop-Limit or Stop, the quantity of shares, a limit price, for Limit and Stop-Limit orders, an activation price, for Stop and Stop-Limit orders, and a fulfillment option ‘All-or-Nothing’ or ‘Partial’. The information may be submitted through a graphical user interface on a client computer or other interface and the information is received by a server. The user is also prompted to type in a security code such as that from an OTP token. All actions involving trading accounts (including order cancellation) require a two-factor authentication process as discussed above in the permission based system and order entry detail.

Once the order is received by the web interface on the server 720, a basic check is performed to verify that the user's account has sufficient funds or shares to carry out the requested trade 722. After the check is complete the order details are passed to the back-end order execution system on the server 730. The execution system itself comprises three functional units: application nodes, data nodes and management/replication nodes. Preferably though not required, each functional unit comprises at least two identically configured servers to allow for load-balancing and failover. The application node places the incoming order into a serialization queue 732 (ordered by placement time) and then inserts it into a database 734. Insertion of the order into the database 734 occurs in a transaction that also freezes a portion of the user's account's cash balance or number of shares commensurate with the order details. As a security and back up, before clearing the new order for execution, the application node may optionally synchronize data with the database cluster in a separate geographic location hosting a backup of the entire transferable private securities system to ensure that the order will be available for processing should the primary system be subsequently rendered inoperable.

After the order is confirmed, the application node executes the order 736 by invoking matching logic to identify all combinations of marketable contra-orders for the given symbol within the bounds of the specified limit price (if any) that exactly (in the case of ‘All-or-Nothing’ orders) or partially (in the case of ‘Partial’ orders) fulfill the quantity of shares requested 738. The total cost of each of those combinations is then assessed and the one with the lowest dollar amount, in the case where the driving order is a ‘Bid’, or the highest dollar amount, in the case of an ‘Ask’, is chosen for clearing 740. In the event that no suitable combinations of marketable contra-orders is found and the order is a ‘Market’ or recently activated ‘Stop’ order, the order is considered ‘failed’ and not submitted to the order books 750. ‘Limit’ and recently activated ‘Stop-Limit’ orders that cannot be completely fulfilled for which ‘Partial’ fulfillment has been specified are placed into the order books with the remaining requested quantity indicated 760. Submitted ‘Stop’ and ‘Stop-Limit’ orders which are not immediately activated are placed into storage, to be placed on the order books upon activation 770.

The transferable system further may employ an alternate method (not shown) when trading volume or order book size increases. In the alternative method, contra-orders are considered in groups of two or more. This grouping has the effect of reducing the number of combinations that must be considered when searching for a match, allowing orders to be executed in a shorter amount of time, as not all possible contra-order combinations are evaluated. However, this alternate method cannot guarantee that the match set proposed for clearing is that with the lowest or highest possible price.

When a matching set of contra-orders has been selected, internal clearing logic is invoked on the application server to facilitate the provisional exchange of cash and shares. First, the clearing logic checks the cash balance or holdings of each account to verify that adequate funds or shares are present in each. If all actors are capable of fulfilling their role in the trade, the clearing logic transfers funds from the purchaser(s) to the seller(s), moves shares from the seller(s) to the purchaser(s), updates the order books, marks orders fully or partially complete as appropriate, and records all movement of shares to the transaction log 780. The purchasers' cash balances are debited by the amount of their purchase, and the newly purchased shares are marked as “Pending Holdings,” such that the shares cannot be sold or otherwise disposed of until settlement has completed. Likewise, the sellers' stock holdings are debited by the amount of the sale, and the cash proceeds from the sale are marked as “Pending Balance,” such that the cash cannot be withdrawn or used in another transaction until settlement has been completed. The trade is then communicated to the clearing broker-dealer, which clears and settles the trade. If the clearing and settling process fails, the trade is unwound, such that the buyer retains the shares and the seller retains the cash that had been provisionally transferred.

Once a successful trade has occurred, the application server activates any ‘Stop’ or ‘Stop-Limit’ orders triggered by the transaction price. Activated ‘Stop’ orders are placed at the front of the order execution queue as ‘Market’ orders, whereas activated ‘Stop-Limit’ orders are placed among the ‘Limit’ orders awaiting execution. Both the ‘Market’ and ‘Limit’ sections of the order processing queue are ordered by order placement time. When execution of the current driving order is complete, the application server takes the next order in the processing queue and begins the process again.

In one embodiment of a transferable private security system as described in conjunction with FIG. 6, the offering is a fixed price primary or initial offering. An offering of this nature may be closed at anytime by the company. If a fixed price offering is made, sales are completed on a “first come first served” basis, until the offering is filled.

In another embodiment of a transferable private security systems as described in conjunction with FIG. 6, a primary offering is performed using a form of Dutch auction, where bids are collected and then the highest price that the offered shares can be sold, if any, is calculated (the “Clearing Price”). Bids are submitted to the transferable private security system platform and then communicated to the clearing broker. The clearing broker then transfers the funds to an escrow account established with a bank to hold the funds until the close of the offering and the determination of the clearing price and allocation. Once the auction has closed, the allocation of shares and the price per share are transmitted to the clearing broker dealer. The clearing broker dealer forwards the information to the escrow company, which works with the issuer to have stock certificates issued in the name of the new buyer and the bids of the losing bidders (as well as the excess bids of the winning bidders) are returned to the clearing broker dealer who ensures the money is returned to the bidders' accounts.

In the Dutch auction embodiment there are two basic parts to the auction, the clearing price calculation and the allocation of shares among winning bids.

The clearing price is a mathematically-defined price that represents the highest price at which all of the shares offered by the company can be sold. After the bidding is closed, the clearing price is calculated for example by: (1) for each price per share at which a bid was placed (pᵢ), computing the sum of all the shares for which bids were placed at that price (sᵢ), (2) starting with the highest price and working the way down toward the lowest price, adding up sᵢ until the cumulative sum is equal to or greater than the number of shares the company wishes to offer (S), and (3) the clearing price is the pᵢ associated with the final sᵢ which made the cumulative sum equal to or greater than the number of shares the company wishes to offer.

In the event that a clearing price does not exist, a company can reduce the number of shares offered by a certain percentage, as long as such is provided for in the offering term sheet. If the company reduces the number of shares offered all shares must be sold at the minimum price accepted by the company.

In contrast, if the company has more bids than expected, it may increase the number of shares that it offers by a certain percentage, as long such is provided for in the offering term sheet. After the number of shares offered is increased, the clearing price is recomputed, as the increase in the number of shares has the potential to decrease the clearing price.

Once a clearing price has been computed, the offering price is by default set to the clearing price. However, if provided for in the term sheet the company may set the offering price below the clearing price in order to increase the number of bids that receive shares.

All shareholders who are allocated shares in the offering pay the offering price for those shares regardless of the allocation method used. Shares may be allocated in a number of different ways once the offering price has been set. One embodiment of an allocation is the conventional allocation provided for in U.S. Pat. No. 6,629,082. In this conventional method, first, all of the bids whose price is higher than the clearing price are awarded the full number of shares bid upon, and then the remaining shares are distributed pro rata to the bids whose price is equal to the clearing price.

An embodiment of the system where the offering price is lower than the clearing price results in an increase of the number of shares requested by successful bids. As a result, the allocation process must be adjusted.

One method of allocating shares when offering price is lower than the clearing price is a price-based allocation using the method described above.

Another embodiment of a method for allocating shares, is a share-based allocation. The basic principle behind share-based allocation is to give preference to those bids that are for larger number of shares, regardless of the price that they bid on those shares. In this embodiment, the shares are distributed according to its fraction of the total number of shares above the offering price, rounding down to the nearest integer for each bid, and then distributing any shares left over by giving one share to each of the bids in the order the bid was placed, from earliest to latest. This allocation method may also be applied to lots, i.e., when shares are grouped so that a minimum number of shares must be purchased by any one buyer.

In a modified form of the share-based allocation, the lots or shares are allocated so that every winning bidder gets at least one lot or share.

Another embodiment for allocating shares is a value-based allocation. In a value-based allocation the basic idea is to allocate shares based on the percentage of the total value (shares*price per share) bid upon by successful bids.

In another auction allocation embodiment, after the clearing price is determined, allocation commences with the highest bidder, who is awarded all of his lots that are bid on. The next highest bidder is then awarded all of his shares. This allocation continues until the last person receives only a portion of the shares based upon the remaining shares. In the event multiple people have bid at the lowest price, they equally split the remaining lots.

As noted previously the forgoing descriptions of the specific embodiments are presented for purposes of illustration and description. They are not intended to be exhaustive or to limit the invention to the precise forms disclosed and obviously many modifications and variations are possible in view of the above teachings, including equivalents. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

1. A system for sales of privately held securities comprising:
a host processing module accessible to a prospective buyer of privately held securities over a network;
a database module accessible to said host processing module for storing information about an issuing company's private offerings;
an authorization module accessible to said host processing module, said authorization module adapted to receive a request from a buyer of privately held securities for permission to obtain confidential data pertaining to the issuing company from said database module and to obtain permission from the issuing company;
a bid/ask module accessible to said host processing module, said bid ask/module adapted to match bids and asks for privately held securities of the issuing company;
a reporting module, said reporting module adapted to compile matching bids and asks for privately held securities of the issuing company; and
a clearing module, said clearing module adapted to clear and settle a transfer of privately held securities corresponding to matching bids and asks.

2. The system of claim 1, wherein the transfer of the privately held securities is a primary sale.

3. The system of claim 1, wherein the transfer of the privately held securities is a secondary sale.

4. The system of claim 2, further comprising an electronic execution module, said electronic execution module adapted to populate and then execute share transfer documents on behalf the issuing company and said buyer.

5. The system of claim 4, further comprising a waiver module, said waiver module being adapted to allow the waiver of rights of first refusal.

6. The system of claim 3, further comprising an electronic execution module, said electronic execution module adapted to populate and then execute share transfer documents on behalf the issuing company and said buyer.

7. The system of claim 6, further comprising a waiver module, said waiver module being adapted to allow the waiver of rights of first refusal.

8. The system of claim 5, wherein said database includes a virtual road show, informational video, audited financials or other disclosure from the issuing company.

9. The system of claim 1, further comprising an account module, said account module adapted to receive an account creation request from a buyer.

10. The system of claim 1, wherein said authorization module uses a predefined criteria to approve or deny to the permission request.

11. The system of claim 1, wherein the ask is predetermined and the bid from the buyer must equal the ask.

12. The system of claim 1, wherein the ask is initially set at a highest desired priced and may be subsequently lowered.

13. The system of claim 1, wherein the clearing module is further adapted to perform an allocation of matching bids.

14. The system of claim 13, wherein the allocation of matching bids is a price-based allocation.

15. The system of claim 13, wherein the allocation of matching bids is a share-based allocation.

16. A system for sales of privately held securities comprising:
a host processing module accessible to a prospective buyer of privately held securities over a network;
a database module accessible to said host processing module for storing information about an issuing company's private offerings;
an authorization module accessible to said host processing module, said authorization module adapted to receive a request from a buyer of privately held securities for permission to obtain confidential data pertaining to the issuing company from said database module and to obtain permission from the issuing company;
a bid/ask module accessible to said host processing module, said bid ask/module adapted to match bids and asks for privately held securities of the issuing company;
a reporting module, said reporting module adapted to compile matching bids and asks for privately held securities of the issuing company;
a clearing module, said clearing module adapted to clear and settle a transfer of privately held securities corresponding to matching bids and asks; and
an electronic execution module, said electronic execution module adapted to populate and then execute share transfer documents on behalf the issuing company and said buyer.

17. The system of claim 16, further comprising a waiver module, said waiver module being adapted to allow the waiver of rights of first refusal.

18. A system for automatically executing transfer documents, comprising:
a permission module adapted to obtain permission of buyers and sellers to allow automatic execution of transfer documents;
a finalization module adapted to populate transfer documents with transfer terms and then complete and execute the documents on behalf of buyers and sellers that have granted permission for automatic execution.

19. A method for de-coupling the rights of shares of preferred stock comprising:
converting the shares of preferred stock into an identical number of shares of new common stock with voting rights; and
creating a corresponding number of slugs, wherein each slug represents the value of the preferred share over the new common share but has no voting or preference rights.

20. A system for transferring illiquid assets comprising:
a host processing module accessible to a prospective buyer of illiquid assets over a network;
a database module accessible to said host processing module for storing information about the illiquid asset;
an authorization module accessible to said host processing module, said authorization module adapted to receive a request from a buyer illiquid assets for permission to obtain confidential data pertaining to the asset from said database module and to obtain permission;
a first processing module, said first processing module adapted to calculate the highest price for which the illiquid asset can be sold;
a bid/ask module accessible to said host processing module, said bid ask/module adapted to determine the price for which the illiquid asset will be sold and allocate the illiquid asset to said buyers.
a reporting module, said reporting module adapted to compile matching bids and asks for the illiquid asset; and
a clearing module, said clearing module adapted to clear and settle a transfer of the illiquid asset corresponding to matching bids and asks.
